(19) United States
(12) Patent Application Publication
(10) Pub. No.: US 2025/0038217 A1
(43) Pub. Date: Jan. 30, 2025

(54) Electrochemical Cell Design With Polymer Composite Layer

(71) Applicant: APPLE INC., Cupertino, CA (US)

(72) Inventors: Alan A. Ritchie, Menlo Park, CA (US); Malar A. Azagarsamy, Fremont, CA (US)

(21) Appl. No.: 18/226,813

(22) Filed: Jul. 27, 2023

(51) Int. Cl. H01M 4/66; H01M 10/0525

(52) U.S. Cl. CPC H01M 4/667; H01M 4/662; H01M 10/0525; H01M 2004/021

(57) ABSTRACT

An electrochemical cell has a cathode, a lithium metal anode, a separator between the cathode and the lithium metal anode, a liquid electrolyte, and a polymer composite layer bonding the lithium metal anode to the separator. The polymer composite layer includes a crosslinked polymer backbone, polyethylene glycol, polycaprolactone, and one or more lithium salt.

### TECHNICAL FIELD

This disclosure relates to an electrochemical cell design using a high energy density lithium metal anode and having a polymer composite layer between the cathode and the lithium metal anode.

### BACKGROUND

Lithium metal batteries have received significant attention as advanced high-performance next generation batteries. The lithium metal battery is attractive due to its high volumetric and gravimetric energy densities. However, the lithium metal anode is not compatible with the commonly used liquid electrolytes in lithium-ion cells, causing large irreversible anode volume increases with insufficient electrochemical reversibility, resulting in low energy density and low cycle life, respectively. Modifying the composition of the liquid electrolyte may not lead to a viable cell design, as the lithium metal anode still reacts with the liquid electrolyte and develops non-uniform and fluffy lithium plating. The direct contact between the liquid electrolyte and the lithium metal anode leads to continuous reaction at the lithium metal interface, which consumes the liquid electrolyte and forms an unfavorable solid electrolyte interface (SEI) layer. Loose contact between the lithium metal anode and the separator allows the fluffy lithium dendrites to grow into the liquid electrolyte space. Other factors, such as non-uniform current distribution at the lithium metal interface, particularly at high current rates, attribute to non-uniform and fluffy lithium plating. The resulting structural instability limits the applications of these batteries. Applying external pressure in an attempt to limit the thickness growth of the lithium metal anode does not eliminate the dendritic, fluffy morphology and is unfavorable or infeasible in many practical applications.

### SUMMARY

Disclosed herein are implementations of an electrochemical cell design that includes a cathode, a lithium metal anode, a separator between the cathode and the lithium metal anode, a liquid electrolyte, and a polymer composite layer bonding the lithium metal anode to the separator. The polymer composite layer includes a crosslinked polymer backbone, polyethylene glycol, polycaprolactone, and one or more lithium salt.

Also disclosed herein is an electrochemical cell as fabricated, having a cathode with a cathode current collector and a cathode active material, an anode comprising an anode current collector, lithium metal on the anode current collector, and an anode cap layer on the lithium metal opposite the anode current collector. The anode cap layer consists of one or more metals, at least one of the one or more metals alloyed with the lithium metal. The electrochemical cell also has a separator between the cathode active material and the anode, a liquid electrolyte, and a polymer composite layer bonding the anode cap layer to the separator. The polymer composite layer consists of a crosslinked polymer backbone, polyethylene glycol, polycaprolactone, and one or more lithium salt.

Also disclosed is a lithium metal battery comprising one or more electrochemical cells as disclosed herein, wherein the lithium metal battery has an external operating pressure of 20 psi or less.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic of an electrochemical cell design as disclosed herein.

FIG. 2 is a scanning electron microscopy/energy-dispersive X-ray spectroscopy (SEM/EDS) image of a surface of a layer of polymer backbone with polyethylene Glycol only.

FIG. 3 is an SEM/EDS image of a surface of a layer of polymer backbone with polycaprolactone only.

FIG. 4 is an SEM/EDS image of a surface of a polymer composite layer as disclosed herein with 17.0 wt % lithium salt as fabricated.

FIG. 5 is an SEM/EDS image of a surface of a polymer composite layer as disclosed herein with 34.0 wt % lithium salt as fabricated.

FIG. 6 is a graph comparing degree of crystallinity of various polyethylene glycols, polycaprolactone, and both polyethylene glycol and polycaprolactone with the polymer backbone and the polymer backbone only.

FIGS. 7A and 7B are graphs comparing the tensile strain and stress of polymer composite films containing various polyethylene glycols, polycaprolactone, and both polyethylene glycol and polycaprolactone blended with the polymer backbone and the polymer backbone only.

### DETAILED DESCRIPTION

Although lithium metal batteries are attractive due to their high volumetric and gravimetric energy densities, the lithium metal anode is not compatible with conventional liquid electrolytes used in the lithium-ion cell. This incompatibility results in non-uniform lithium plating and fluffy lithium plating, causing performance issues that can limit the applications of these batteries. The non-uniform and fluffy lithium plating can be caused, in part, by 1) contact between the liquid electrolyte and the lithium metal anode, which leads to continuous reaction at the lithium metal interface, consuming the liquid electrolyte and forming an unfavorable SEI layer; 2) loose contact between the lithium metal anode and the separator, which allows the fluffy lithium dendrites to grow into the liquid electrolyte space; and 3) non-uniform current distribution at the lithium metal interface. The non-uniform and fluffy lithium plating cause the swelling of the anode, which lowers the volumetric energy density of the cell. External applied pressure to the cell may be helpful for denser lithium plating, but has not been shown to eliminate the dendritic, fluffy morphology. Furthermore, external pressure is unfavorable or infeasible in many practical applications. An external pressure fixture is undesirable as it requires extra volume and weight around a cell. Such design offsets the energy density gains the cell design with a lithium metal anode, rather than a graphite anode, is providing. This situation adversely impacts smaller, often volume sensitive consumer electronic devices more than larger batteries, such as those used in electric vehicles. The larger batteries might, to some extent, tolerate a common, light pressure fixture for an entire array of multiple cells in which the weight addition formally allocated to each cell remains limited. However, as noted, external pressure has not solved the dendritic, fluffy lithium morphology and its resulting performance degradation.

Protective layers have been added to electrochemical cells between the liquid electrolyte and the lithium metal anode. The protective layers known to date, however, continue to have drawbacks. It is challenging to have a protective layer that is sufficiently lithium ion conductive. It is challenging to have a protective layer that is not so porous as to allow too much penetration of the liquid electrolyte, eventually reaching the lithium metal. It is challenging to have a protective layer that is not too brittle or too stiff, which decreases mechanical strength, decreases adhesion, and provides no flexibility to adapt to the lithium surface roughness.

To address these issues, disclosed herein is an electrochemical cell with a novel polymer composite layer formulated specifically for use with a lithium metal anode and a conventional liquid electrolyte. The polymer composite layers disclosed herein have improved pore control, ion conductivity, and separator bond strength when compared to known protective layers. The polymer composite layers disclosed herein have low stiffness, moderate tensile strength and sufficient elongation, providing the requisite mechanical strength, e.g., the ability to bend without breaking and the ability to absorb impact energy.

The electrochemical cells disclosed herein achieve the high volumetric and gravimetric energy densities with a well bonded stack of layers including an anode current collector, a lithium metal anode, an anode cap layer, a polymer composite layer and a separator. The specific layer sequence of lithium metal, in the form of a lithium metal anode capped with the anode cap layer and protected from the liquid electrolyte by the polymer composite layer, enables dense and uniform lithium plating between the anode current collector and the anode cap layer, creating a liquid electrolyte-free, chemically protected environment during cell cycling. The specific layers and the sequence of the layers avoid low density lithium plating, thereby enabling and retaining high volumetric energy density in conjunction with long cycle life, all without the need for an external pressure fixture.

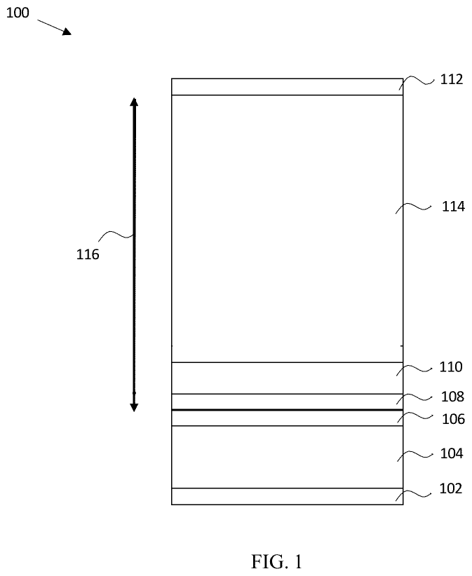

FIG. 1 is a schematic of an electrochemical cell 100 as disclosed herein. The electrochemical cell 100 has an anode current collector 102 and a lithium metal anode 104 deposited on the anode current collector 102. An anode cap layer 106 caps the lithium metal anode 104. A polymer composite layer 108 bonds the anode cap layer 106 to a separator 110. The electrochemical cell 100 also has a cathode current collector 112 and a cathode active material 114 deposited on the cathode current collector 112. Liquid electrolyte 116 is represented with the arrow.

The electrochemical cells 100 disclosed herein provide solutions to the problems discussed herein by using a spatially separated, and thus chemically separated, lithium metal anode from the liquid electrolyte via interposing the combination of the anode cap layer 106 and the polymer composite layer 108, with the anode cap layer 106 in direct contact with the lithium metal anode 104 and the polymer composite layer 108 in direct contact with the liquid electrolyte 116, as illustrated in FIG. 1. The polymer composite layer 108 takes up lithium salt and solvent molecules from the liquid electrolyte 116 during cycling to convert the as-fabricated polymer composite layer 108 to a polymer electrolyte layer while limiting the interaction between the lithium metal anode 104 and the solvent and promoting a uniform interface at the anode cap layer 106. The electrochemical cells 100 disclosed herein provide low impedance and uniform, bonded solid-state interfaces. These bonded interfaces avoid a liquid electrolyte interface with the lithium metal anode, preventing the uncontrolled growth of low density, high volume, dendritic, fluffy lithium metal morphology into the liquid electrolyte space.

Multiple electrochemical cells 100 can be stacked in a multi-cell design in which current collectors between cells are double sided. The design allocates half of the current collector thickness and weight to adjacent unit cells. Any multiple of cells can be incorporated.

The cathode current collector 112 can be, for example, an aluminum sheet or foil. Other metal and alloy materials are contemplated. The cathode current collector 112 can have a thickness of 6 μm to 12 μm. Cathode active material 114 can include one or more lithium transition metal oxides which can be bonded together using binders and optionally conductive fillers such as carbon black. The cathode active material can have a thickness of between 1 μm and 500 μm. Lithium transition metal oxides can include, but are not limited to, LiCoO₂, LiNiO₂, LiNi_{0.8}Co_{0.15}Al_{0.05}O₂, LiMnO₂, Li(Ni_{0.5}Mn_{0.5})O₂, LiNiₓCo_{y}Mn_{z}O₂, spinel Li₂Mn₂O₄, LiFePO₄ and other polyanion compounds, and other olivine structures including LiMnPO₄, LiCoPO₄, LiNi_{0.5}Co_{0.5}PO₄, and LiMn_{0.33}Fe_{0.33}Co_{0.33}PO₄. In some embodiments, the cathode active material may be composed of only electrochemically active material, such as sintered LCO. In other embodiments, the cathode active material 114 may include one or both of carbon and a binder.

The separator 110 is a porous, tortuous mechanical layer or membrane that physically separates the cathode active material from the polymer composite layer. The porosity of the separator 110 laminated to the polymer composite layer 108 disclosed herein can be increased from a conventional porosity of about 30-40% to 60% or greater. The separator 100 can be between 0.1 μm and 30 μm in thickness and may be composed of a single layer or multi-layer of organic or inorganic materials, such as polyolefins and glass fibers, respectively. The separator may be coated on one or both sides with organic (e.g., polyvinylidene fluoride (PVdF)) and/or inorganic (e.g., magnesium hydroxide (Mg(OH)₂)) materials. The single sided separator coating may preferably be a coating at the cathode side. Alternatively, the separator coating at the cathode side may be provided by a coating on the cathode, rather than a coating on the separator.

The liquid electrolyte 116 will penetrate the separator as well as the cathode active material 114 and to the extent described the polymer composite layer 108, while contacting the cathode current collector 112, and should be compatible with all four layers under all operation conditions. The liquid electrolyte, while not being limiting, can be composed of at least one lithium salt (e.g., lithium bis(fluorosulfonyl) imide (LiFSI)) dissolved in at least one organic solvent (e.g., dimethyl carbonate (DMC)) or inorganic liquid solvent. The liquid electrolyte 116 may contain at least one ionic liquid (e.g., Py13FSI) and may contain organic and inorganic additives (e.g., bis(2,2,2-trifluoroethyl) ether (BTFE), lithium bis(oxalato) borate (LiBOB)).

The lithium metal anode 104 can be, for example, a lithium metal seeded on the anode current collector 102 during fabrication. The lithium metal can be between 0.01 μm and 30 μm in thickness. Upon charge, additional lithium metal is plated onto the lithium metal anode. Alternatively, the electrochemical cell can be an anode-free cell, meaning the cell is fabricated without a lithium metal anode on the anode current collector, and the lithium metal deposits between the anode current collector 102 and the polymer composite layer 108 during charging. The anode current collector 102 can be a copper, nickel, or titanium sheet or foil, as a non-limiting example. The anode current collector 102 can be between 4 μm and Sum in thickness.

The anode cap layer 106 consists of one or more metals, at least one of the one or more metals alloyed with the lithium metal of the anode 104. The anode cap layer 106 can be from 0.01 μm to 10 μm in thickness, and in particular from 0.2 μm to 3.0 μm, and is composed of the maximally lithiated alloy of a given metal M that is capable of forming an inter-metallic compound with lithium. M may comprise one or more metal elements (ternary, quaternary, quinary, etc.) and may be selected from Sn, Sb, Si, Au, Zn, Al, and Mg, as non-limiting examples. M may also contain elements which, if binary, would only form solid solutions with lithium, such as Cu, Ti, and Ni.

LiSn is a non-limiting example of the anode cap layer. A galvanic cell is formed when lithium and tin are in contact, which drives alloy formation to a stable situation at low temperatures. LiSn also diffuses lithium ions very quickly. LiSn has a diffusion coefficient of about 10⁻⁷ cm²/s, while LiPON and LiCoO₂ have diffusion coefficients of 10⁻⁹ cm²/s and 10⁻¹⁰ cm²/s. Lithium and tin are both active materials. Adding an inactive matrix such as Cu, Ti, Ni, or NiTi can provide further stability as these components will not react or move within the layer layer. Non-limiting examples of the anode cap layer include LiSnCu, LiSnTi, LiSnNi, and LiSnNiTi. These layer compositions may be formulated such that, for example, the LiSnCu layer may be Cu rich, or the LiSnCu layer may be coated with a Cu skin near the polymer composite layer 108. By the same token, the LiSnNiTi layer, for example, may be Ni or Ti rich, or may be coated with a Ni, Ti, or NiTi skin near the polymer composite layer 108.

The anode cap layer is in contact with an excess amount of lithium metal, in the form of the lithium metal anode, and thus adopts the maximally lithiated alloy possible for M during a given cell's life. Empirically, it was found that upon cell charge the lithium atoms plate densely and uniformly between the anode cap layer 106 and the existing lithium metal at very low impedance while fusing with the latter. This location of lithium plating is desired. A reason that the lithium atoms prefer to plate between the anode cap layer and the lithium metal anode, rather than the anode cap layer and the polymer composite layer, is rooted in a thermodynamic voltage gradient which disappears not until the incoming lithium atoms reach the lithium metal anode bulk. Upon discharge, the plated lithium is stripped off uniformly. The polymer composite layer can be used in an electrochemical cell without the anode cap layer, with the polymer composite layer laminating the separator to the lithium metal or anode current collector. However, the inventors have found that the anode cap layer enables flatter and denser plating of the lithium metal.

The anode cap layer can be formed from an in-situ reaction layer of, for instance, vacuum deposited M onto the lithium metal anode followed by a controlled surface passivation with, for instance, CO₂ gas or mixtures thereof or ex-situ dip solutions containing diluted carboxylic acids in hydrocarbon. Other approaches exist to form the anode cap layer, such as, for instance, (i) dip coating of the lithium metal anode into a solution that contains salt(s) of M with which the lithium metal anode seed reacts to LiₓM or (ii) providing salt(s) of M as additives in the polymer composite layer, wherein the lithium metal anode reacts in-situ at its surface to LiₓM when the polymer composite layer slurry is applied onto the lithium metal anode.

The polymer composite layer 108 has a crosslinked polymer backbone, polyethylene glycol (PEG), polycaprolactone (PCL), and at least one lithium salt. These can be the sole components of the polymer composite layer 108 as fabricated. It is contemplated that additional components may be included but are not necessary. It is noted that during cell charge and discharge, the polymer composite layer may take up lithium salt and a finite amount of solvent from the liquid electrolyte 116, while limiting the interaction between the anode and the solvent and promoting a uniform interface at the anode cap layer 106. With the exception of the casting solvent, which is evaporated from and does not remain in the as fabricated polymer composite layer, no ionic liquid or other solvents are used or remain in the as fabricated polymer composite layer. The polymer composite layer 108 can be between about 0.01 μm and 5.0 μm in thickness, and more particularly, from about 1.5 μm to 3.0 μm in thickness.

The crosslinked polymer backbone is a cross-linked polymer having an un-crosslinked molecular weight of between 100,000 g/mol and 2,000,000 g/mol and is between 40.0 wt % and 90.0 wt % of the as-fabricated polymer composite layer 108. All ranges herein are inclusive. The polymer backbone is a polymer that is stable with lithium metal and the metals of the anode cap layer and is resilient to dissolution in the liquid electrolyte 116 with minimal swelling. The polymer backbone provides a structural matrix to host the PEG and PCL and provides the bonding (lamination) between the separator and anode. The polymer of the polymer backbone can be poly(vinylidene fluoride)-co-hexafluoropropylene (PVDF-HFP), poly(vinylidene fluoride) (PVDF), polyethylene glycol dimethacrylate (PEGDMA), polydiallyldimethylammonium bis(fluorosulfonyl) imide (polyDDA FSI), polyvinyl butyral (PVB), poly(urethane acrylate) (PUA), polyethylene glycol (PEO), polyacrylonitrile (PAN), poly(methyl methacrylate) (PMMA), or a copolymer thereof. The crosslinked polymer backbone can be one polymer or can be a mixture of more than one polymer. The polymer backbones can be in a fully or partially crosslinked form, and the crosslinking within the backbone can be achieved by both chemical crosslinking (during synthesis) and physical crosslinking (such as the dissociated lithium salt coordination with the polymer's fluorine atoms).

The PEG has a molecular weight between 20,000 g/mol and 200,000 g/mol and is between 1.0 wt % and 20.0 wt % of the as fabricated polymer composite layer 108. The PCL has a molecular weight between 20,000 g/mol and 200,000 g/mol and is between 1.0 wt % and 40.0 wt % of the as fabricated polymer composite layer 108. Both the PEG and the PCL can be linear or branched with 3, 4, 6 or 8 arms. The molecular weight range provides a suitable window to enable the PEG and PCL to plasticize in the presence of the liquid electrolyte 116 but not dissolve. The ratio of PCL to PEG in the polymer composite layer is 1:1 to 3:1. The addition of PEG and PCL creates free volume for the lithium salt and a finite amount of solvent from the liquid electrolyte, enables lithium salt dissociation and lithium ion conductivity, provides added structural support to the polymer composite layer, and provides additional bonding to the anode and separator.

The lithium salt can be one or more than one of LiFSI, lithium bis(trifluoromethanesulfonyl)imide (LiTFSI), LiBOB, lithium hexafluorophosphate (LiPF₆), lithium tetrafluoroborate (LiBF₄), and lithium perchlorate (LiClO₄), as non-limiting examples. As a non-limiting example, a dual salt system can be used, such as LiFSI and LiBOB. The addition of the lithium salt(s) to the polymer composite layer 108 improves the ionic conductivity and improves low temperature performance. LiBOB, in particular passivates the aluminum cathode current collector to suppress SFI-Al corrosion. The lithium salt is 30.0 wt % or less of the as fabricated polymer composite layer 108.

Lithium salt is necessary for ion conduction. However, known polymer electrolytes may depend solely on the salt for ion conduction and are gated by the need for large amounts of the lithium salt and its inherent pore forming action. The higher porosity (20% or greater) and larger pores (maximum pore diameters of 2 μm or greater) in a polymer electrolyte film are undesirable as liquid electrolyte is permitted to react with the underlying lithium metal anode. The mechanism which creates the large pores was the use of high concentrations of salt and a casting solvent. During the film processing, the solvent evaporates, leaving behind pores filled with salt. To resolve this, additional means of lithium ion conduction was sought, independent of the lithium salt.

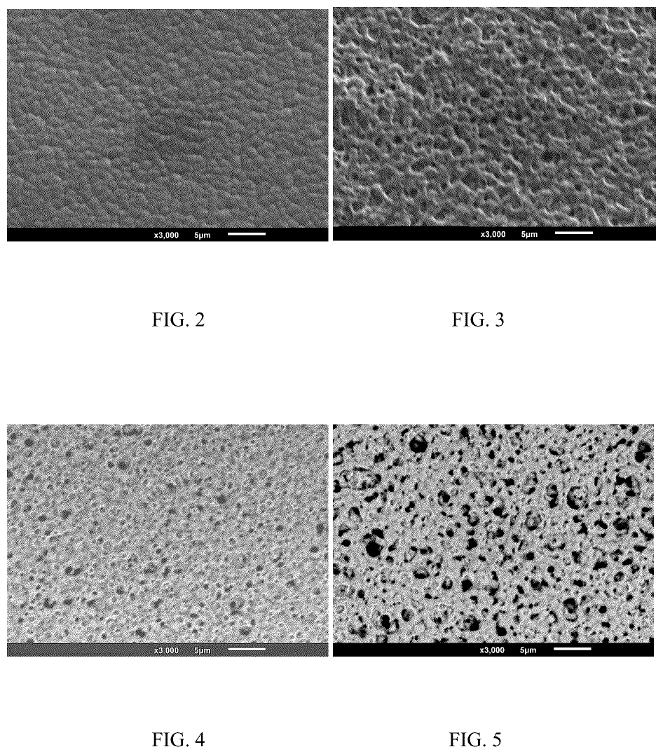

The addition of PEG enhances the ion conductivity in the polymer composite layer 108. However, the use of PEG alone provides a dense polymer film with no visible pores. FIG. 2 is an SEM/EDS image of the surface of a polymer backbone (PVDF-HFP used here) with 40,000 g/mol molecular weight 8 arm PEG, showing no visible pores. The ion conductivity is not sufficient without some introduction of lithium salt, and the lack of porosity only enables very small amounts (less than 5.0 wt %) of lithium salt to be added before non-uniform, undesirable porosity occurs.

To resolve the porosity issues, it was found that PCL produces a unique pore forming property when combined with the polymer backbone. PCL forms smaller (≤1.0 μm maximum diameter), more uniform pores than that that occurs when forming pores with the addition of lithium salt. FIG. 3 is an SEM/EDS image of the surface of a polymer backbone (PVDF-HFP used here) with 80,000 g/mol molecular weight PCL, showing small, uniform pores. Blending the PCL and PEG results in small, uniform pores filled with PEG, which is ion conductive. With PCL as the pore former and PEG as the pore filler, varying the ratio of PEG and PCL with in the polymer composite layer enables the tuning of the porosity of the polymer composite layer. The desired porosity is sufficient to provide the requisite ion conductivity but as low as possible to limit the pooling of the liquid electrolyte solvent. The polymer composite layer 108 disclosed herein has a porosity of between 1.0 wt % and 10.0 wt %, more particularly, between 1.0 wt % and 8.0 wt %, and more particularly, between 1.0 wt % and 5.0 wt %.

With the use of PEG for ion conductivity, the amount of lithium salt required to achieve the overall ion conductivity in the polymer composite layer can be reduced. For example, the ratio of lithium salt to the total of the crosslinked polymer backbone, PEG, and PCL is less than 0.4:1.0, and more particularly 0.2:1, compared to ratios of 1.1:1.0 of lithium salt to polymer in known polymer electrolyte layers. FIGS. 4 and 5 are SEM/EDS images illustrating the impact of increased lithium salt concentration of the pore size and uniformity. FIGS. 4 and 5 are images of the surfaces of polymer composite layers prior to bonding with the separator. The polymer composite layer has 20 wt % total of PEG and PCL and 80 wt % of PVDF-HFP and the ratio of PCL to PEG is 3:1. In FIG. 4, the lithium salt is 17.0 wt % of the polymer composite layer, resulting in 8.0% porosity, while in FIG. 5, the lithium salt is 34.0 wt % of the polymer composite layer, resulting in 19.0% porosity. With both PEG and lithium salt contributing to the ion conductivity, the lower concentrations of lithium salt achieve a polymer composite layer 108 with an ion conductivity of ≥0.6×10⁻⁴ S/cm⁻¹. The polymer composite layer acts as a protective layer to block contact between the liquid electrolyte and the lithium metal anode, reducing or preventing the continuous reaction between the electrolyte and the lithium metal. The polymer composite layer serves as an additional electrolyte layer as the polymer composite layer is lithium ion conductive, promoting uniform lithium distribution and plating at the electrode interface.

The combination of the PEG and the PCL have other synergistic effects. PEG is more polar than PCL, allowing the polarity of the polymer composite layer to be tuned by varying the ratio of PEG to PCL.

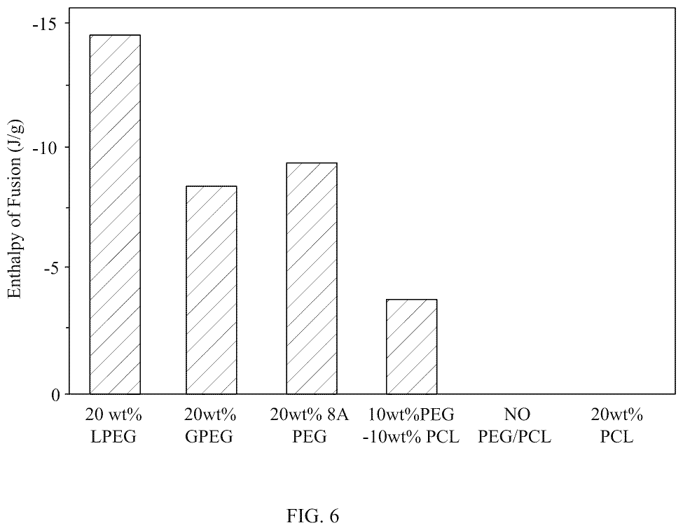

PCL does not form a separate melting peak/crystalline phase, integrating will with the polymer backbone and lithium salt system. PEG forms separate crystalline phases as its polarity is significantly different from the polymer backbone. Blending PEG and PCL reduces the crystallinity of PEG, enhancing the polymer chain mobility and improving the room temperature conductivity of the polymer composite layer. See the graph in FIG. 6, illustrating the crystallinity of PEGs, PCL, a mixture of PEG and PCL, and no PEG or PCL. The higher the enthalpy of fusion, the greater the degree of crystallinity. Crystallinity makes a material strong, but also makes it brittle. The polymer composite layers disclosed herein have the ability to bend without breaking and to absorb impact energy.

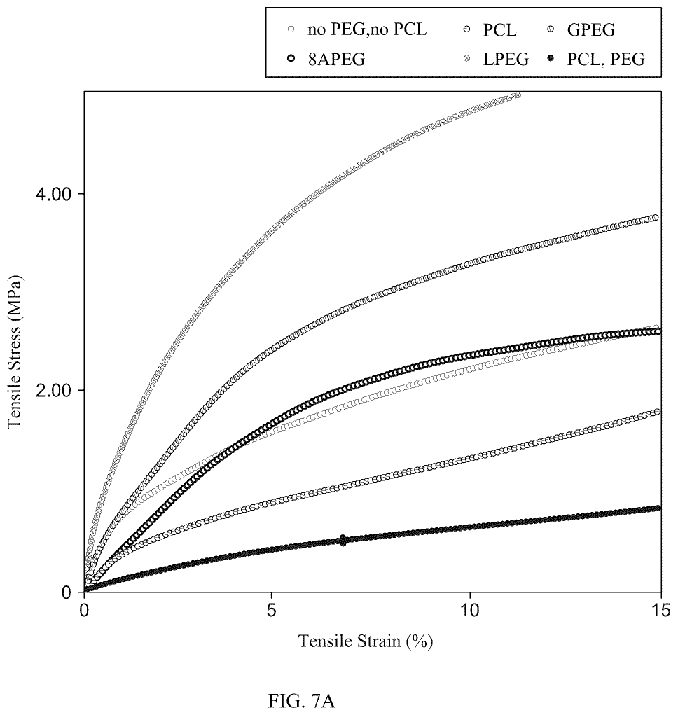

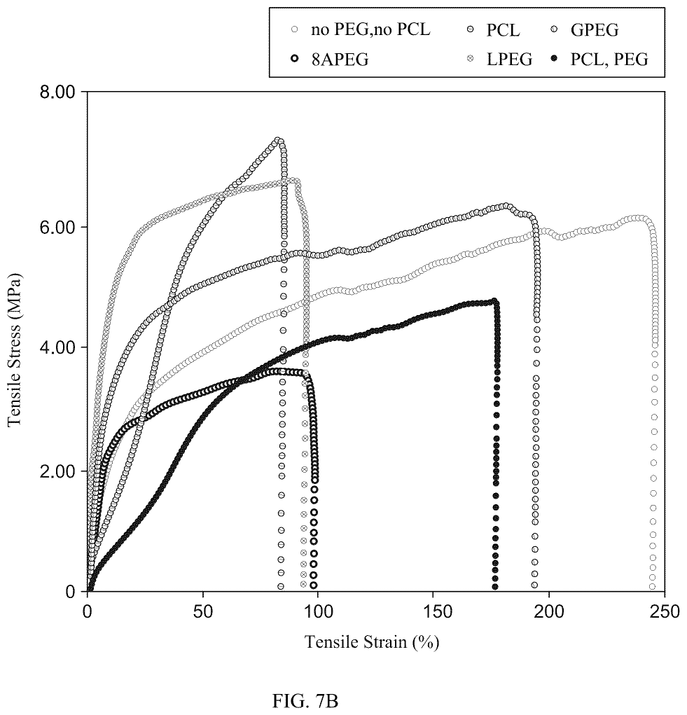

Blending of PEG and PCL lowers the stiffness, provides moderate tensile strength and longer elongation, and renders the polymer composite layer highly elastomeric. When a material has a higher stiffness, it is harder and has less adhesion. It also has no flexibility to adapt to the lithium surface roughness. The polymer composite layers disclosed herein have lower stiffness, moderate tensile strength and longer elongation, providing an excellent bonding material to adhere the separator to the anode. FIGS. 7A and 7B illustrate the elastomeric properties of polymer films containing PEG alone, PCL alone, only polymer backbone, and blended PEG and PCL. The elastomeric properties of the blended PEG and PCL are shown with the low-evolution slope, which reflects its lower stiffness and high elongation at break.

The polymer composite layer serves to laminate, or bond, the anode, whether it's the anode cap layer or lithium metal, to the separator, providing strong adhesion between the layers. The internal pressure provided by the bond onto the lithium metal facilitates dense lithium plating at low or no external pressure. The combination of the polymer backbone, PEG, and PCL provide excellent bond strength between the anode and separator, exceeding 60 N/m peel strength, and even reaching 70 N/m peel strength using a 7 day LE soak test of the anode, polymer composite layer, and separator. To achieve this strong bonding, the polymer composite layer slurry is cast onto the anode cap layer (or lithium metal of the anode if no cap layer) before the separator is laid into the slurry before the slurry is dry. The created bond strength is a function of the polymer composite layer, the casting solvent, and the post-cast drying conditions. The casting solvent can be dimethylacetamide (DMAc), dimethylformamide (DMF), N-methyl-2-pyrrolidone (NMP), tetramethylurea (TMU), N,N-diethylacetamide (DEAc), triethyl phosphate (TEP) and mixtures thereof. The casting solvent is not part of the as fabricated polymer composite layer or electrochemical cell.

The combination of the strong bonding of the separator to the anode and the reduced porosity of the polymer composite layer enables the use of a separator with increased porosity. Separators with a porosity of 60% or greater can be used, compared to a conventional 40% or less separator porosity, which reduces internal cell resistance. The increased separator porosity also improves the elastic behavior of the separator and the layers to which it is bonded, which better accommodates lithium plating non-uniformities.

The polymer composite layer 108 disclosed herein reduces the non-uniform and fluffy lithium plating while lowering or eliminating external operating pressure requirements on the battery, resulting in stable cell performance. The electrochemical cell stack design with the polymer composite layer bonding the separator to the anode allows cycling at 0 psi external operating pressure and C/3 charge rate. Upwards of 240 cycles are realized at greater than 80% discharge capacity, a 60% improvement over conventional lithium battery cell designs.

Two embodiments of the polymer composite layers 108 as fabricated disclosed herein are provided in the table below.

| | Embodiment 1 | Embodiment 2 |
|---|---|---|
| PVDF-HFP wt % | 62.25 | 56.25 |
| PCL wt % | 14.37 | 12.98 |
| PEG wt % | 6.38 | 5.77 |
| LiFSI wt % | 13.79 | 20.28 |
| LiBOB wt % | 3.21 | 4.73 |
| Total lithium salt wt % | 17.0 | 25.01 |
| Ratio of PCL to PEG | 2.25:1 | 2.25:1 |
| Ratio of lithium salt | 0.2:1 | 0.33:1 |
| to total polymer | | |
| Porosity | 8% | 10% |

It is to be understood that the terminology used herein is used for the purpose of describing particular embodiments only and is not intended to limit the scope of the disclosure. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Unless defined otherwise, all technical and scientific terms used herein have the same meanings as commonly understood by one of ordinary skill in the art to which this invention belongs.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An electrochemical cell as fabricated, comprising:
a cathode having a cathode current collector and a cathode active material;
an anode comprising:
an anode current collector;
lithium metal on the anode current collector; and
an anode cap layer on the lithium metal opposite the anode current collector, the anode cap layer consisting of one or more metals, at least one of the one or more metals alloyed with the lithium metal;
a separator between the cathode active material and the anode;
a liquid electrolyte; and
a polymer composite layer bonding the anode cap layer to the separator, the polymer composite layer consisting of:
a crosslinked polymer backbone;
polyethylene glycol;
polycaprolactone; and
one or more lithium salt.

2. The electrochemical cell of claim 1, wherein the crosslinked polymer backbone has an un-crosslinked molecular weight of between 100,000 g/mol and 2,000,000 g/mol and is selected from the group consisting of PVDF-HFP, PEGDMA, polyDDA, PVB, PUA, PEO, PAN, PMMA, and copolymers thereof.

3. The electrochemical cell of claim 2, wherein the crosslinked polymer backbone is PVDF-HFP.

4. The electrochemical cell of claim 1, wherein the one or more lithium salt is LiFSI, LiTFSI, LiBOB, LiPF₆, LiBF₄, or LiClO₄.

5. The electrochemical cell of claim 4, wherein the one or more lithium salt is LiFSI and LiBOB.

6. The electrochemical cell of claim 1, wherein the one or more lithium salt is 30.0 wt % or less of the polymer composite layer.

7. The electrochemical cell of claim 1, wherein the polymer composite layer provides a peel strength of greater than or equal to 60 N/m between the anode and the separator.

8. The electrochemical cell of claim 1, wherein the polyethylene glycol has a molecular weight between 20,000 g/mol and 200,000 g/mol and is between 1.0 wt % and 20.0 wt % of the polymer composite layer.

9. The electrochemical cell of claim 1, wherein the polycaprolactone has a molecular weight between 20,000 g/mol and 200,000 g/mol and is between 1.0 wt % and 40.0 wt % of the polymer composite layer.

10. The electrochemical cell of claim 1, wherein the polymer composite layer has a porosity of less than 10.0%.

11. The electrochemical cell of claim 1, wherein a ratio of the one or more lithium salt to a total of the crosslinked polymer backbone, the polyethylene glycol, and the polycaprolactone is less than 0.4:1.0.

12. The electrochemical cell of claim 1, wherein the one or more metals of the anode cap layer are Sn and Cu.

13. A lithium metal battery, comprising:
the electrochemical cell of claim 1, wherein the lithium metal battery has an external operating pressure of 20 psi or less.

14. An electrochemical cell, comprising:
a cathode;
a lithium metal anode;
a separator between the cathode and the lithium metal anode;
a liquid electrolyte; and
a polymer composite layer bonding the lithium metal anode to the separator, the polymer composite layer comprising:
a crosslinked polymer backbone;
polyethylene glycol;
polycaprolactone; and
one or more lithium salt.

15. The electrochemical cell of claim 14, wherein the polyethylene glycol has a molecular weight between 20,000 g/mol and 200,000 g/mol and is between 1.0 wt % and 20.0 wt % of the polymer composite layer.

16. The electrochemical cell of claim 14, wherein the polycaprolactone has a molecular weight between 20,000 g/mol and 200,000 g/mol and is between 1.0 wt % and 40.0 wt % of the polymer composite layer.

17. The electrochemical cell of claim 14, wherein the polymer composite layer has a porosity of less than 10.0%.

18. The electrochemical cell of claim 14, wherein the crosslinked polymer backbone is PVDF-HFP.

19. The electrochemical cell of claim 14, wherein the one or more lithium salt is LiFSI and LiBOB.

20. The electrochemical cell of claim 14, further comprising:
an anode cap layer on the lithium metal anode, the anode cap layer consisting of one or more metals, at least one of the one or more metals alloyed with the lithium metal anode.
